(19) United States
(12) Patent Application Publication
(10) Pub. No.: US 2025/0274797 A1
(43) Pub. Date: Aug. 28, 2025

(54) INTER-CELL BEAM MANAGEMENT IN A WIRELESS COMMUNICATION SYSTEM

(71) Applicant: GOOGLE LLC, Mountain View, CA (US)

(72) Inventor: Jia-Hong Liou, Mountain View, CA (US)

(21) Appl. No.: 18/858,938

(22) PCT Filed: Apr. 24, 2023
(86) PCT No.: PCT/US23/19671

§ 371 Date: Oct. 22, 2024

Related U.S. Application Data
(60) Provisional application No. 63/363,481, filed on Apr. 22, 2022.

(51) Int. Cl. H04W 24/10; H04L 5/00

(52) U.S. Cl. CPC H04W 24/10; H04L 5/0048

(57) ABSTRACT

To configure inter-cell measurements at a user equipment (UE), a RAN node transmits, to the UE, a resource set including (i) a list of N resources for signal measurement and (ii) a list of N indices corresponding to the N resources, each index in the list of N indices referencing an identifier of a cell with which the signal measurement is associated. The RAN node receives, from the UE, a measurement report based on the resource set.

### CROSS-REFERENCE TO RELATED APPLICATION

This application claims priority to and the benefit of the filing date of provisional U.S. Patent Application No. 63/363,481, titled “Method and Apparatus for Enabling Inter-Cell Beam Management in a Wireless Communication System,” filed on Apr. 22, 2022. The entire contents of the provisional application are hereby expressly incorporated herein by reference.

### FIELD

This disclosure relates generally to wireless communications and, more particularly, to measuring reference signals in neighboring cell at a user equipment (UE).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer. The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to quickly transition back to the RRC_CONNECTED state.

At the PHY layer, there are several known approaches to beam indications for high-frequency bands. In New Radio (NR)/5G, different beam indication techniques can apply to different channels and reference signals (SRs). A Transmission Configuration Indication (TCI) framework and TCI states generally apply to most downlink (DL) transmissions, e.g., Physical Downlink Shared Channel (PDSCH), Physical Downlink Control Channel (PDCCH), Channel State Information Reference Signal (CSI-RS). However, PDCCH further requires a MAC control element (MAC-CE) to further indicate one of the configured TCI states, and PDSCH indicates this information using MAC-CI and downlink control information (DCI). For PUSCH transmissions, an indication of the uplink (UL) beam relies on the index of the SRS resource which the UE used for transmission at least once. For PUCCH, a MAC-CE indicates a spatial relation for the UE. In some cases, a spatial relation applies to an SRS resource set, in which the same UL beam is applicable to all SRS resources in the SRS resource set. Although this approach provides higher flexibility for beam indication, it also introduces large signaling overhead, when most channels or RSs share the same beam.

The 3rd Generation Partnership Project (3GPP) recently introduced a unified TCI framework for beam indications, for DL and UL transmissions. According to one of the use cases, a network entity indicates a common beam appliable to DL channels/RSs and/or UL channels/RSs. 3GPP further introduced inter-cell beam measurement and beam reporting. Generally speaking, inter-cell beam management (beam measurement, beam reporting, etc.) allows a UE to measure and report the quality of beams and/or RSs from neighboring cells, rather than merely in the cell in which the UE currently operates, i.e., the serving cell. In response to an inter-cell beam report, a network entity such as a base station can select a beam from a neighboring cell for a downlink (DL) transmission and/or UL transmission. When a UE indicates a DL transmission by referring to an RS from a neighboring cell, the UE impliedly received the DL transmission from a transmission and reception point (TRP) or node in the neighboring cell.

However, UEs and network entities lack efficient techniques for reporting inter-cell beam measurements.

### SUMMARY

Generally speaking, a network entity (e.g., base station) operating in a radio access network (RAN) configures a UE for performing and reporting inter-cell beam management in a wireless communication system according to a certain efficient configuration. The configuration can indicate, directly or indirectly through indices, the Physical Cell Identifier (PCI) of at least one cell other than the serving cell of the UE. The configuration can include for example a PCI list configuration in which an integer in the PCI list configuration is associated with a certain PIC. This integer can correspond to an SSB in the CSI-SSB resource list. Further, a CI report configuration can include the index of the appropriate CSI report configuration. The UE then transmits the results of the inter-cell beam measurement to the RAN

In particular, an example embodiment of these techniques is a method for configuring inter-cell measurements at a UE. The method is implemented in a RAN node and comprises transmitting, to the UE, a resource set including (i) a list of N resources for signal measurement and (ii) a list of N indices corresponding to the N resources, each index in the list of N indices referencing an identifier of a cell with which the signal measurement is associated; and receiving, from the UE, a measurement report based on the resource set.

Another example embodiment of these techniques is a method for performing inter-cell measurements implemented in a UE. The method comprises receiving, from a radio access network (RAN), a resource set including (i) a list of N resources for signal measurement and (ii) a list of N indices corresponding to the N resources, each index in the list referencing an identifier of a cell with which the signal measurement is associated; and transmitting, to the RAN, a measurement report based on the resource set.

Still another example embodiment of these techniques is a device comprising an antenna set and processing hardware configured to implement one of the methods above.

### BRIEF DESCRIPTION OF THE DRAWINGS

FIG. 1A is a block diagram of an example system in which a base station and/or a user equipment (UE) can implement the techniques of this disclosure;

FIG. 1B is a block diagram of an example distributed base station including a central unit (CU) and a distributed unit (DU), which can operate in the system of FIG. 1A;

FIG. 2A is a block diagram of an example protocol stack according to which the UE of FIG. 1A can communicate with base stations;

FIG. 2B is a block diagram of an example protocol stack according to which the UE of FIG. 1A can communicate with a DU and a CU of a base station;

FIG. 3A illustrates an example configuration of a resource set including a resource list and associated PCI index list of equal length;

FIG. 3B illustrates an example configuration of which a resource inclufing includes a resource list and a corresponding PCI index list of a different length;

FIGS. 4A-E illustrate several example formats of a CSI report which the UE of FIG. 1A can transmit; an example in which one or more CSI fields are positioned in a CSI report;

FIG. 5 is a flow diagram of an example method for configuring inter-cell measurement, which can be implemented in a RAN node of FIG. 1A; and

FIG. 6 is a flow diagram of an example method for performing inter-cell measurement, which can be implemented in a UE of FIG. 1A.

### DETAILED DESCRIPTION

A UE and network entity (e.g., a base station) of this disclosure implement inter-cell measurement and reporting techniques to allow a UE to efficiently indicate signal measurements for the serving cell and at least one other cell. To this end, the network entity formats a resource set with a list of resources for signal measurement as well as a list of indices corresponding to these resources. The UE can use the list of indices to quickly identify the physical cells to which the resources belong.

More specifically, it is desirable for a single instance of a beam report to indicate an RS from the serving cell as well an as RS from a neighboring cell so that, rather than transmitting separate reports for the serving cell and for each of the neighboring cell, a UE can transmit a single beam report when the RSs from the serving cell and the neighboring cell qualify for the report. The existing messaging mechanisms for RRC however do not support such reports. For inter-cell beam measurement based on a synchronization signal block (CSI-SSB) resource set, RRC currently allows a device to configure only the Physical Cell Identifier (PCI) index of a neighboring cell in a CSR-SSB resource set, and a beam report for a CSI-SSB resource set reports only the SSB index of the neighbor. Further, when a network entity receives a beam report from a UE, the network entity cannot determine to which neighboring cell the SSB index belongs.

### Example Communication System

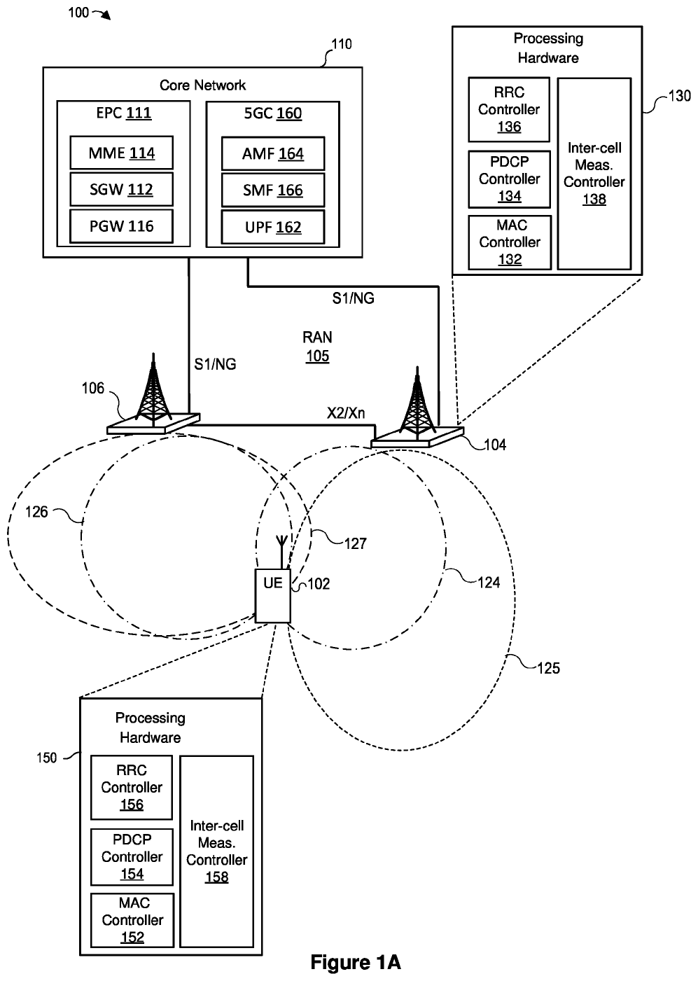

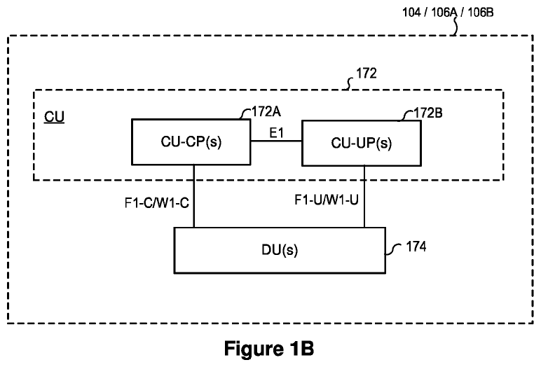

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers cells 124 and 125, and the base station 106 covers cells 126 and 127. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104. 160 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack.

The processing hardware 130 in an example implementation includes an inter-cell measurement controller 138 configured to configure inter-cell signal measurements at the UE 102 and process signal measurement reports from the UE 102. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an inter-cell measurement controller 158 configured to process inter-cell signal measurement configurations, perform inter-cell signal measurements according to these configurations, and report the measurements to the base station 104 or 106. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to, in some scenarios, transmit DL PDCP PDUs in accordance with which the base station 106 can transmit data in the downlink direction, and, in further scenarios, receive UL PDCP PDUs in accordance with which the base station 106 can receive data in the uplink direction.

The UE 102 can be equipped with one or more antenna panels (or just “panels”). The UE 102 can configure and activate one or more of the panels for DL reception at the same time or within the same time interval. The 102 also can configure and activate one or more of the patents for UL transmission, also to occur at the same time or within the same time interval. The set of the active panels for DL reception can be the same, partially different, or fully different from the set of the active panels for UL transmission.

Next, FIG. 1B depicts an example distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

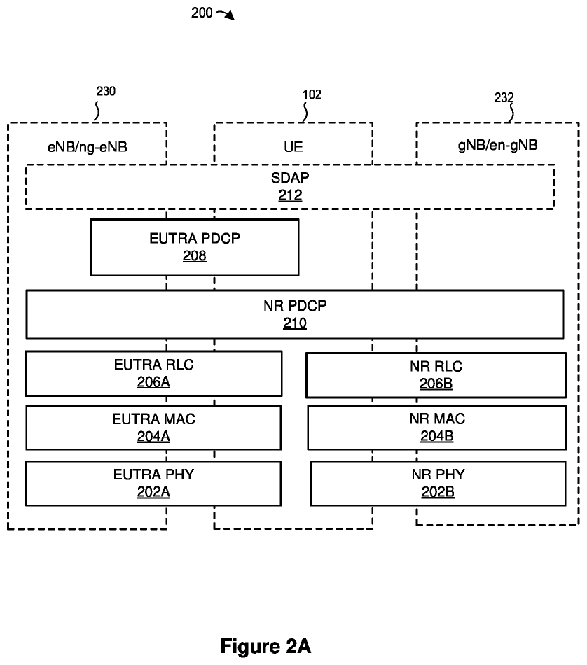

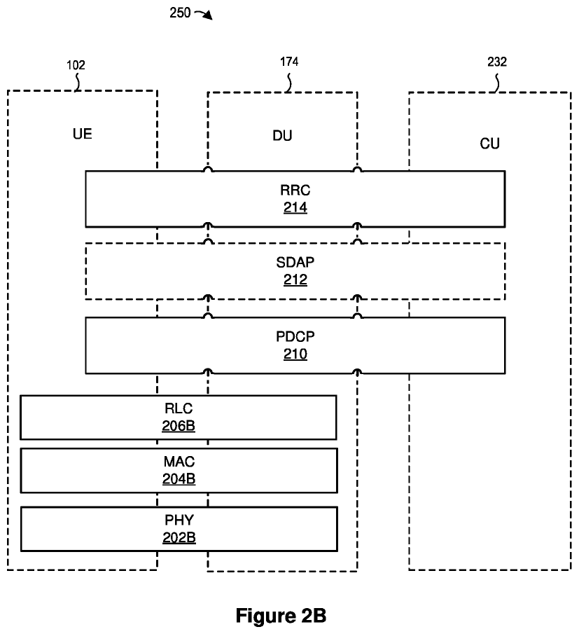

FIG. 2A illustrates, in a simplified manner, an example protocol stack 200 according to which the UE 102 can communicate with an NB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to a NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

The DU 174 is an example of a transmission and reception point (TRP) which provides network coverage and directly communicates with UEs such as the UE 102. A TRP provides service in one or more cells. As discussed above, a base station can be distributed or non-distributed. The term “base station” also can apply to a network central unit or a network node used to control one or multiple TRP, and accordingly can refer to the CU 172 or to the entire station 104 or 106, which can be an eNB, a gNB, a NodeB, etc.

### Example Cell Configuration

In example operation, the cell 124 is the currently serving cell of the UE 102, e.g., the UE 124 currently camps on the cell 124 or has an active radio connection with the base station 104 in the cell 124. The UE 120 in the scenarios of this disclosure can operate in any one of RRC_CONNECTED, RRC_INACTIVE state, or RRC_IDLE. In some scenarios, the UE 102 has more than one serving cell, e.g., when the UE 102 operates in dual connectivity. In this example configuration, the cells 125, 126, and 127 are the neighboring (or non-serving) cells relative to the serving cell 124. Each of the cells 124-127 has a different PCI. The coverage of the cell 124-127 corresponds to the coverage of the corresponding one or more TRPs. A cell also can be referred to as a TRP group (TRPG).

In the serving cell 124, the corresponding TRP generates a serving beam for transmission and/or reception. Other beams, such as the beam which the base station 106 generates for the cell 126, are candidate beams.

Further, the UE 102 can operate on one or more bandwidth parts (BWPs). For example, the RAN 105 can configure the UE 102 with a certain active BWP, which can include an active DL BWP and an active DL BWP. A certain BWP can be an initial BWP, and this BWP (or another BWP) can be the default BWP. Another BWP can be a dormant BWP, to which the UE 102 can switch under certain circumstances.

In some scenarios, the UE 102 performs DL reception from, and/or UL transmission to, a first TRP located in the serving cell. A second TRP can be located in the serving cell or in a neighboring (non-serving) cell. The serving cell and the non-serving cell have different PCIs.

In some implementations, the UE can obtain (e.g., receive as a part of configuration) the value of a TRP identifier associated with a TRP. A DL transmission can include the TRP identifier of the TRP that generated the DL transmission. Similarly, an UL transmission can include the TRP identifier of the TRP configured to receive the UL transmission. The TRP identifier can be associated with a CORESETPoolIndex, a value (candidate) of a CORESETPoolIndex, dataScramblingIdentityPDSCH, dataScramblingIdentityPDSCH2-r16 or PUCCH-ResourceGroup-r16.

In some implementations, the UE receives through configuration, initialization, etc. panel identifiers to identify a panel of the UE. A DL transmission can include a panel identifier identifying the (DL) panel at which the UE is configured to receive the DL transmission. Further, a UL transmission can include a panel identifier identifying the (UL) panel at which the UE generates the UL transmission. The panel identifier can be be associated with a SRS resource set index, or a (candidate) value of an SRS resource set index.

### Inter-Cell Beam Measurement

In an example scenario, the UE 102 communicates with one or more of the neighboring cells 125-127 (in addition to the serving cell 124). The UE 102 receives a DL transmission, and/or transmits a UL transmission, to the one or more of the cells 124-127. The UE 102 can be configured to measure one or more neighboring cells, which the RAN 105 can include in a neighboring cell list or an additional cell list, during configuration.

In some cases, the RAN 105 can configure the UE 102 with one or more resource sets. The UE 102 can use these resource sets for channel measurement and/or for beam measurement. The UE 102 also can use these resource sets for reporting measurement metrics based on at least one of Layer 1 Reference Signal Received Power (L1-RSRP), L1 Signal to Interference plus Noise Ratio (L1-SINR), or Reference Signal Received Quality (RSRQ). The UE 102 can use one or more resource sets for beam reporting, for the serving cell and/or one or more of the one or more neighboring cells.

The 102 can be configured to perform inter-cell beam measurement, in which case the UE 102 performs beam measurement (e.g., L1-RSRP/L1-SINR measurement and/or reporting, or resource measurement without reporting) for at least one of the one or more neighboring cells 125-127. Similarly, when the UE 120 is configured to perform inter-channel beam measurement, the UE 102 performs channel measurement (e.g., CQI/PMI/RI/LI/i1 measurement and/or reporting) for at least one of the one or more neighboring cells 125-127.

The UE 102 can receive one or more CSI report configurations and/or one or more CSI resource configurations. A CSI report configuration can include a CSI resource configuration.

A CSI report configuration may be associated with, or include an index of, a CSI resource configuration, which in turn can include (or be associated with) one resource set from the one or more resource sets. Further, a report configuration can include (or be associated with) one resource set from the one or more resource sets. A CSI report configuration can include the index of a resource set.

The UE 102 can generate a CSI report with measurement results corresponding to the resource set with index included in the CSI report configuration. When generating a CSI report according to the CSI report configuration, the UE 102 can perform measurements using the resources in the resource set with the index included in the CSI report configuration. The UE 102 the transmits the CSI report according to the CSI report configuration.

A CSI report configuration in various implementations or scenarios includes one or more of the following: (i) an indication of time-domain properties of the CSI report (e.g., periodic, semi-persistent or aperiodic), (ii) report quantity, (iii) report Frequency Configuration, and (iv) an indication of whether the CSI report operates as a group-based beam report. The UE 102 generates a CSI report for channel measurement, beam measurement, beam reporting, and/or RSRP/SINR reporting.

In an example implementation, when the UE 102 receives a CSI report configuration with report quantity set to Rank Indicator (RI), Precoding Matrix Indicator (PMI), Channel Quality Information (CQI), Layer Indicator (LI), or i1, the UE 102 generates a CSI report for channel measurement. On the other hand, when the UE 102 receives a CSI report configuration with report quantity set to RSRP (e.g., L1-RSRP, or L3-RSRP), SINR (e.g., L1-SINR), or NULL, the UE 102 generates a CSI report for beam measurement.

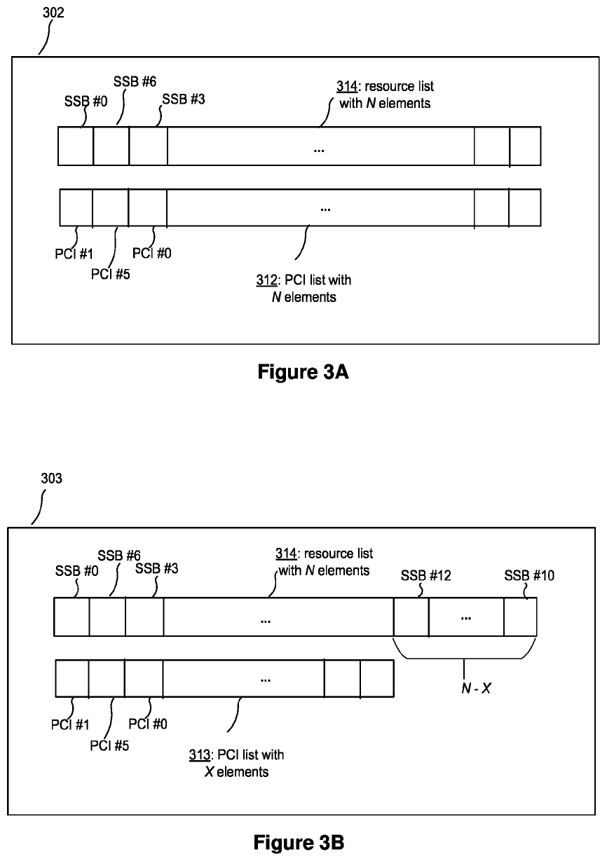

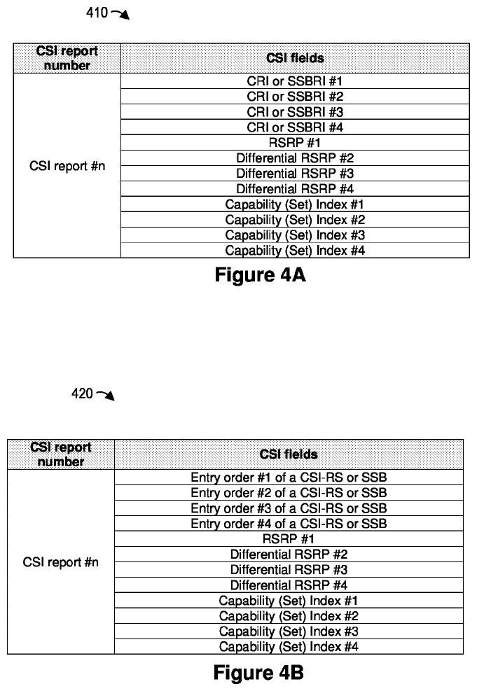

Now referring to FIGS. 3A and 3B, the RAN 105 can configure the UE 102 with a resource set 302 including a PCI list 312 of N elements (FIG. 3A) or a resource set 303 with a PCI list 313 of X elements, X<N (FIG. 3B). The resource set 302 or 303 in some embodiments conforms to the definition of a CSI-SSB-ResourceSet information element. The RAN 105 in general can configure the UE 102 with multiple resource sets with a structure similar to that of the resource set 302 or 303. Each entry in the PCI list 312 or 313 in one implementation is a PCI in the range of [0, 1007] or, in another implementation, a PCI index in the range of [0, 7], identifying a PCI in another list.

According to 3GPP TS 38.331, the CSI-SSB-ResourceSet IE is used to configure one SS/PBCH block resource set which refers to SS/PBCH as indicated in ServingCellConfigCommon. The IE ServingCellConfig is used to configure (add or modify) the UE with a serving cell, which may be the SpCell or an SCell of an MCG or SCG. The ServingCellConfig IE includes a filed additionalPCIList-r17, defined as a sequence of SIZE 1..max NrofAdditionalPCI-r16 of SSB-MTC-AdditionalPCI-r17 elements. The IE SSB-MTC is used to configure measurement timing configurations, i.e., timing occasions at which the UE measures SSBs. The SSB-MTC-AdditionalPCI-r17 IE includes, among other fields, a fied additionalPCIIndex-r17 of type AdditionalPCIIndex-r17, and field additionalPCI-r17 of type PhysCellId.

More generally, a PCI list can include, or be associated with, one or more PCIs, and each entry in the PCI list can be an index, an entry order, an integer used for another type of identification, etc. A PCI index of a PCI can correspond to the entry order of the PCI in the PCI list. Depending on the implementation, the entry order can be counted from the most significant bit position or the least significant bit position in the PCI list. In another implementation, the PCI index of a PCI is an integer associated with the PCI through corresponding configuration. In FIGS. 3A and 3B, for example, the PCI list 312 or 313 includes elements as indices PCI #1, PCI #5, and PCI #0.

As indicated above, a PCI is different from a PCI index, in at least some of the embodiments. Whereas the range of PCI is [0, 1007], the range of a PCI index can be significantly smaller and can depend on the number of neighboring cells. One such example range is [0, 7]. More particularly, the RAN 105 can configure the UE 102 with a certain PCI via a broadcast message such as SIB, MIB, PBCH or SSB, and also configure the UE 102 with a corresponding PCI index.

The resource set 302 or 303 further includes a resource list 314 made up of N (one or more) SSBs or SSB indices SSB #0, SSB #6, SSB #3, etc. The resource set 302 or the first resource list 312 in some implementations includes only SSBs, in other implementations includes only SSB indices, and in some implementations includes both SSBs and SSB indices. Each resource in the resource list 314 in some implementations includes only CSI-RS values or only CSI-RS indices. The resource list 314 in some implementations corresponds to a non-zero-power (NZP) NZP CSI-RS mode.

As illustrated in FIG. 3A, the PCI list 312 can include the same number N of entries or elements as the number N of entries or elements in the resource list 314. Each of the SSB indices in the resource list 314 can correspond to each of PCI (or PCI index) in the PCI list 312. The correspondence between the SSB indices in the list 314 and the PCI indices (or the actual PCIs) in the list 312 can be based on the order of elements in these lists. Thus, when each entry in the list 314 is an SSB index, and each entry in the list 312 is a PCI index, SSB index #0 corresponds to PCI index #1 because both are the first entries in the respective lists 314, 312. More specifically, the format of FIG. 3A in this manner indicates that a TRP in the neighboring cell with a PCI mapped to the PCI index #1 transmits an SSB with the SSB index #0. Similarly, SSB index #6 corresponds to PCI index #5 based on the order in the lists 314, 312, and thus a TRP in the neighboring cell with a PCI mapped to the PCI index #5 transmits an SSB with the SSB index #6.

As illustrated in FIG. 3B, the number X of elements or entries in the PCI list 313 is different from the number N of SSB or SSB indices in the resource list 314. In general, the number of elements in the PCI list 313 can be smaller or greater than the number of elements I the resource list 314. In the example of FIG. 3B. X<N. Some SSB or SSB indices in the resource list 314 can correspond or belong to the serving cell. The N−X entries at the tail of the resource 314 in this example correspond to the serving cell of the UE 102 (including SSB index #10 and SSB index #12). In another implementation, however, the N−X entries corresponding to the serving cell are the head of the list. More generally, the N−X entries can be disposed in the list 314 in any suitable manner.

In some cases, the RAN 105 is configured set the number of elements or entries in a PCI list to a number lower than the number of SSB or SSB indices in the resource list 314. The UE 102 in this implementation expects that the number of elements or entries in the PCI list is smaller or equal to the number of SSBs or SSB indices in the resource list 314. If the UE 102 receives a resource set with more entries in the list 312 or 313 than in the list 314, the UE 102 discards the CSI resource set, the CSI resource list, or only the PCI list, depending on the implementation. The UE 102 further can associate an error or misconfiguration with the CSI resource set, the CSI resource list, or the PCI list.

As discussed above, the PCI list 312 or 313 can include PCI indices corresponding to neighboring cells. The PCI list 312 or 313 also can include a certain PCI index corresponding to the serving cell.

In one such implementation, the PCI index corresponding to the serving cell has the highest candidate value of a PCI index. In another implementation, the PCI index corresponding to the serving cell has the lowest candidate value of a PCI index. For example, if the total number of neighboring cells configured for a UE is 7, the highest candidate value of a PCI index is #7. PCI indices from #0 to #6 can correspond to neighboring cells, and PCI index #7 can corresponding to the serving cell. As another example, PCI indices from #1 to #7 can correspond to neighboring cells, and PCI index #0 can corresponding to the serving cell. In still another implementation, a certain preselected value between #1 to #6 can correspond to the serving cell.

In at least some of the embodiments, the RAN 105 does not need to configure the UE 102 with the PCI index corresponding to the serving cell, or indicate this value to the UE 102. The UE 102 and the RAN 105 instead can rely on a predefined PCI index for identifying the serving cell. The UE 102 can store this value in the local memory or include this value in the firmware for example. In other implementations, however, the RAN 105 configures the UE 102 with the PCI index corresponding to the serving cell. In the example of FIGS. 3A and 3B, the PCI index #0 is associated with the serving cell, and thus the TRP in the serving cell generates the SSB with the SSB index #3 (based on the order of this entry in the resource list 314).

One example can also be shown in FIG. 3A. Assume that PCI index #0 is associated with the serving cell. In such case, a SSB with SSB index #3 may be correspond to or be transmitted from the serving cell.

In some cases, the RAN 105 configures the UE 102 with another, second resource set that include a second resource list. The second resource list can include one or more SSB or SSB indices. The second resource set or the second resource list can include only SSBs or only SSB indices, depending on the implementation. The second resource also can conform to the definition of the CSI-SSB-ResourceSet IE. The second resource list can include CSI-RSs, CSI-RS indices, etc., and can correspond to a NZP CSI-RS mode.

In some implementations or scenarios, the second resource set does not include a PCI list at all., and includes only one or more resources associated with the serving cell. These resources can be SSB(s) or SSB indices, CSI-RS resource(s) or CSI-RS resource indices, etc.

A CSI report configuration can be associated with both the first resource set (e.g., the resource set (302, 303) and the second resource set discussed above. The CSI resource configuration accordingly can be associated with the first resource set and the second resource set. The CSI report configuration can include the index of the first resource set and the index of the second resource set. The UE 102, in at least some of the implementations, does not use the CSI report configuration for group-based beam report, and uses the CSI report configuration only for non-group-based beam reporting. The CSI report configuration or a related parameter (e.g., groupBasedBeamReporting or groupBasedBeamReporting-r17) accordingly does not configure group-based beam reporting. As a more specific example, the RAN 105 can set the group-based beam report configuration or related parameter (e.g., groupBasedBeamReporting or groupBasedBeamReporting-r17) to “disabled” in the CSI report configuration.

The UE 102 can report or select resource(s) from the first resource set and the second resource set. When the UE 102 prepares a CSI report according to the CSI report configuration, the UE 120 can report or select resource(s) from the first resource set and the second resource set. In one such scenario, the UE 102 reports or selects resources only from the first resource set when preparing the CSI report. In another scenario, the UE 102 reports or selects resources only from the second resource set when preparing the CSI report. In yet another scenario, the UE 102 reports or selects some resources from the first resource set and some resource from the second resource set when preparing the CSI report.

In some cases, the RAN 105 prevents the same SSB index from appearing in both the first resource set and the second resource set. Similarly, the RAN 105 in some cases prevents the same CSI-RS index from appearing in both the first resource set and the second resource set.

The RAN 105 in some cases can allocate resources among the first and resource based on the association of resources with the serving cell or the neighboring cells. For example, the first resource set can include SSB(s) from only the serving cell and/or CSI-RS(s) from only the serving cell, and the second resource set can include SSB(s) and/or CSI-RS(s) from only the one or more neighboring cell. Alternatively, the second resource set can include SSB(s) from only the serving cell and/orCSI-RS(s) from only the serving cell, and the first resource set can include SSB(s) and/or CSI-RS(s) from only the one or more neighboring cell.

The configuration the UE 102 receives in general can be a SSB or SSB-MTC related. In some cases, the configuration includes, or is associated with, one or more of the following types of information: (i) first index, (ii) second index, (iii) periodicity value, (iv) bitmap to indicate the position of SSBs in a burst, (v) power value related to the SSB (for example, the power value can be related to transmission or reception of the SSBs. The first and second indices can be integers, and the second index can refer to, or be associated, with the second index. For example, the first index can be a PCI index, and the second index can be a PCI. In some scenarios, the second index is the PCI of the serving cell. In other scenarios, the second index is the PCI of one of the one or more neighboring cell(s). The configuration can conform to the definition of the SSB-MTC-AdditionalPCI IE.

In some scenarios, the UE 102 ignores or discards one or more parameters in the configuration other than the first index and/or the second index if the second index is the PCI of the serving cell. In other scenarios, the RAN 105 does not include parameters other the first index and/or the second index in the configuration if the second index is the PCI of the serving cell. Further, the RAN 105 in some cases can include parameter(s) other than the first index and/or the second index only if the second index is the PCI of one of the one or more neighboring cells, or if the second index is not the PCI o the serving cell. As a more specific example, the RAN 105 can include the periodicity value, the bitmap, or the power value only if the second index is the PCI of one of the one or more neighboring cells or is not the PCI of the serving cell.

In another embodiment, the UE 102 receives a CSI report configuration associated with inter-cell beam measurement. The UE 102 prepares a CSI report based on the CSI report configuration. The UE 102 for example can receive a CSI resource configuration associated with inter-cell beam measurement. The CSI report configuration can correspond to a CSI resource configuration be associated with a CSI resource set.

The CSI resource set includes only SSBs or SSB indices, and/or only CSI-RSs or CSI-RS indices, in some implementations. When the RAN 105 includes only SSB or SSB indices in the CSI resource set, the UE 102 can determine that it should use CSI resource set or the CSI report configuration for measuring the quality of SSB(s). However, when the CSI resource set includes CSI-RSs or CRIs, the UE 102 can determine that it should use the CSI resource set or the CSI report configuration for measuring the quality of CSI-RS(s).

When the CSI resource set includes SSB or SSB indices, or only SSBs or SSB indicates, one or more of the following can also apply: (i) the CSI resource includes a PCI list, (ii) the UE 102 reports an SSBRI (SSB Resource Index or SSB index) or a measurement metric (e.g., L1-RSRP or L1-SINR) corresponding to the SSBRI in the CSI report. When the CSI resource set includes CSI-RS or CRI (CSI-RS index), or only these parameters, the UE reports a CRI or a measurement metric (e.g., L1-RSRP or L1-SINR) in the CSI report.

In some implementations, the UE 102 reports one or more capability (set) indices in the CSI report. The UE 102 can report one or more capability (set) indices if the UE 102 supports configuration of two SRS resource sets with different maximum configured SRS port numbers, or if the UE supports configuration of two SRS resource sets with different maximum configured SRS resource numbers, or if the UE supports at least two UL panels with different TX port numbers. The UE 102 report one or more capability (set) indices in the CSI report related to SSBRI or CRI.

In some cases, one SSBRI (or CRI) and its corresponding measurement metric form a reporting pair. One SSBRI (or CRI), its corresponding measurement metric, and its corresponding capability (set) index may form a reporting tuple. In some cases, the RAN 105 configures the UE 102 with the maximum number of reporting tuples. In some cases, one CSI report can include at most four reporting tuples. In other cases, a CSI report includes more than four reporting tuples.

In some cases, the measurement metrics associated with reporting tuples or pairs (other than the first reporting pair) have the format of a differential value. A device can compute the differential value or compare the differential value with measurement matric in the first reporting pair.

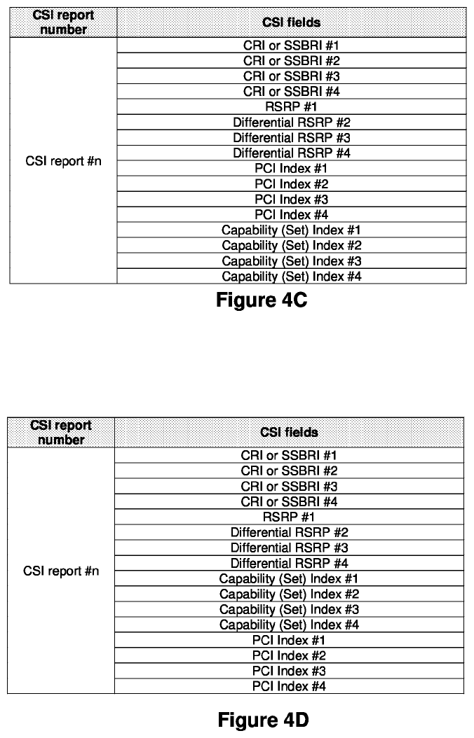

An example format 410 of the CSI report is illustrated in FIG. 4A. CRI/SSBRI #1,RSRP #1, and capability (set) index #1 form a reporting tuple. The UE 102 can transmit the CSI report via a PUCCH resource or a PUSCH resource. The CSI report configuration can specify the PUCCH resource the PUSCH resource for transmitting the CSI report.

In some cases, the CSI report does not directly report SSBRI but report its corresponding measurement metric. The UE 102 can implement this scheme when the CSI report or the CSI resource is for measuring quality of SSB(s), for example.

The UE 102 can report the entry order or entry index of a SSB in the CSI report, where the entry order corresponds to, or is derived from, the entries in the resource list in the CSI resource set. The UE 102 can report the entry order or entry index of a SSB in the CSI report when or if the UE 102 determines that the quality of SSB satisfies a certain criterion and/or the UE 102 selects the SSB to be reported in the CSI report. In this case, a reporting tuple in the CSI report can be {entry order of a SSB, measurement metric of the SSB} or {entry order of a SSB, measurement metric of the SSB, capability (set) index of the SSB}.

In some cases, the UE 102 reports, in the CSI report, a certain value representing an SSB. This value is different from the SSB index. Depending on the implementation, the value is smaller or larger than the SSB index.

Similarly, the UE 102 can report the entry order or entry index of a CSI-RS in the CSI, where the entry order corresponds to, or is derived from, the entries in the resource list in the CSI resource set. The UE 102 can report the entry order or entry index of a CSI-RS in the CSI report, when the UE determines the quality of CSI-RS satisfied a certain threshold and/or the UE 102 selects the CSI-RS to be reported in the CSI report. In this case, a reporting tuple in the CSI report can be {entry order of a CSI-RS, measurement metric of the CSI-RS} or {entry order of a CSI-RS, measurement metric of the CSI-RS, capability (set) index of the CSI-RS}.

In some cases, the UE 102 reports, in the CSI report, a certain value representing an CSI-RS. This value is different from the CSI-RX index and, depending on the implementation, is smaller or larger than the CSI-RS index.

Now referring to a format 420 of FIG. 4B, instead of reporting entry order or entry index, the UE 102 can report an integer associated with an SSB index, when the UE 102 is configured to report the SSB index. Similarly, instead of reporting entry order or entry index, the UE 102 can report an integer associated with a CSI-RS index, when the UE 102 is configured to report the CSR-RS index. The integer can be associated with the SSB index or the CSR-RS index via an appropriate configuration. For example, the RAN 105 can configure the integer as a part of the configuration of the SSB or the CSI-RS.

In some cases, the UE 102 reports a PCI index associated with am SSB in the CSI report. The UE 102 can report the PCI index associated with the SSB in the CSI report, where the PCI index is derived from or indicated in the PCI list in the CSI resource set. The UE 102 can report an SSB (or its SSBRI) and its associated PCI index in the CSI report, when the UE 102 determines that the quality of SSB satisfies a certain threshold and/or the UE selects the SSB to be reported in the CSI report. In this case, a reporting tuple in the CSI report can have the format {SSBRI, measurement metric of the SSB, PCI index}, {SSBRI, measurement metric of the SSB, PCI index, capability (set) index of the SSB}, or {SSBRI, measurement metric of the SSB, capability (set) index of the SSB, PCI index}.

For additional clarity, FIG. 4C, FIG. 4D, and FIG. 4E illustrate further example formats of CSI reports.

The RAN 105 can prevent the CSI report from including the PCI index and capability (set) index at the same time. In some cases, the UE 102 may not report PCI index and capability (set) index in the CSI report at the same time. In some cases, an SSB index in the resource list may be associated with a first PCI index in the PCI list. The SSB index in the resource list may be associated with a second PCI index in the PCI list.

In some cases, the RAN 105 prevents the UE 102 and/or a network entity from associating the first PCI index and the second PCI index with the same SSB index. The RAN 105 also can prevent the UE 102 and/or a network entity from using overlapping or identical SSB indices to refer to multiple cells. Similarly, the RAN 105 can enforce a rule according to which the same CSI-RS index cannot be associated with two neighboring cells.

Further, the RAN 105 can ensure that the UE 102 does not receive the same SSB index in the serving cell or one of the neighboring cells and in another neighboring cell. The RAN 105 can provide a configuration of the SSB index in a configuration for the serving cell, for example. More generally, the UE 102 can receive an SSB index in system information. broadcast information, SSB, SIB, MIB, and/or or PBCH.

In some cases, the SSB index configured for a certain cell (e.g., the serving cell or any of the one or more neighboring cells) may not overlap or match that of another one serving cell (e.g., the serving cell or any of the one or more neighboring cells). Similarly, candidate values for an SSB index for a cell cannot overlap or match the SSB index of another serving cell.

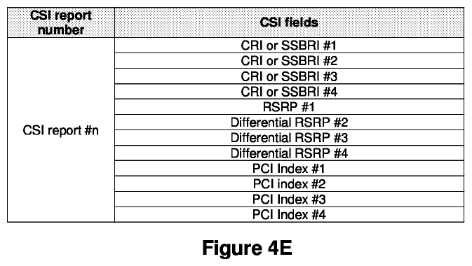

FIG. 5 is a flow diagram of an example method 500 for configuring inter-cell measurement, which can be implemented in a RANO such as the base station 104, 106 or the DU 174, for example. At block 502, the RAN node transmits a resource set including a list of N resources for signal measurement (e.g., SSBs) and a list of N indices (e.g., PCI indices) corresponding to the N resources. As discussed above with reference to FIG. 3A, for example, each index in the list of N indices can reference an identifier of a cell with which the signal measurement is associated. At block 504, the RAN node receives a measurement report based on the resource set. The measurement report can be formatted as discussed above with reference to FIGS. 4A-E, for example.

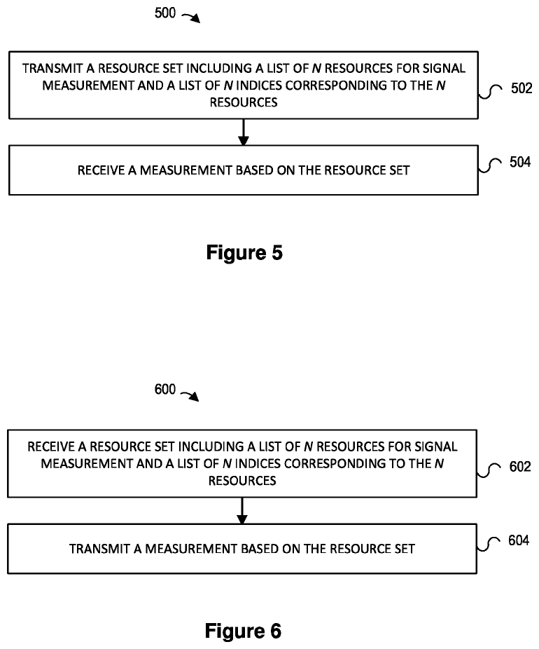

FIG. 6 is a flow diagram of an example method 600 for performing inter-cell measurement. The method 600 can be implemented in the UE 102, for example. At block 602, the UE receives a resource set including a list of N resources for signal measurement (e.g., SSBs) and a list of N indices (e.g., PCI indices) corresponding to the N resources. As discussed above with reference to FIG. 3A, for example, each index in the list of N indices can reference an identifier of a cell with which the signal measurement is associated. At block 604. the UE node transmits a measurement report based on the resource set. The measurement report can be formatted as discussed above with reference to FIGS. 4A-E, for example.

### ADDITIONAL CONSIDERATIONS

It is noted that throughout this disclosure, an expression of “X/Y” may include meaning of “X or Y”. It is noted that throughout this disclosure, an expression of “X/Y” may include meaning of “X and Y”. It is noted that throughout this disclosure, an expression of “X/Y” may include meaning of “X and/or Y”. It is noted that throughout this disclosure, an expression of “(A) B” or “B (A)” may include concept of “only B”. It is noted that throughout this disclosure, an expression of “(A) B” or “B (A)” may include concept of “A+B” or “B+A”.

It is noted that throughout this disclosure, a panel could mean that an antenna (port) group or an antenna (port) set. There may be more than one DL/UL beams associated with one panel. When one transmitting node (UE or NW) is performing a transmission via a panel, only one beam associated with the panel could be used to perform the transmission. For a transmitter comprising more than one panels, e.g., two panels, it may happen that two beams associated with the two panels respectively are used to perform a transmission.

It is noted that throughout this disclosure, a TRP identifier could mean or be referred to a (candidate) value of a TRP identifier. The first TRP identifier could be a first candidate value of a TRP identifier or a first TRP identifier value. The second TRP identifier could be a second candidate value of a TRP identifier or a second TRP identifier value.

It is noted that throughout this disclosure, a panel identifier could mean or be referred to a (candidate) value of a panel identifier. The first panel identifier could be a first candidate value of a panel identifier or a first panel identifier value. The second panel identifier could be a second candidate value of a panel identifier or a second panel identifier value.

It is noted that throughout this disclosure, a TCI field could mean or be referred to a field used or applied or repurposed to indicate one or more TCI states.

It is noted that throughout this disclosure, when a procedure or description is related to a serving cell, it may mean the procedure or description is related to an active (DL/UL) BWP in the serving cell.

It is noted that some or all of the foregoing or the following embodiments could be jointly combined or formed to be a new or another one embodiment.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for configuring inter-cell measurements at a user equipment (UE), the method implemented in a radio access network (RAN) node and comprising:
transmitting, to the UE, a resource set including (i) a list of N resources including synchronization signal block (SSB) indices for signal measurement and (ii) a list of N indices corresponding to the N resources, each index in the list of N indices referencing an identifier of a cell with which the signal measurement is associated; and
receiving, from the UE, a measurement report based on the resource set.

2. The method of claim 1, wherein:
the identifier of a cell is a physical cell identifier (PCI), and the index is a PCI index.

3. The method of claim 2, wherein:
the PCI index is in a range of [0, 7].

4. The method of claim 2, wherein:
the PCI is in a range of [0, 1007].

5. The method of claim 2, further comprising:
transmitting, to the UE, a ServingCellConfig information element (IE) including a list of PCIs, wherein the PCI index refers to the list of PCIs.

6. The method of claim 1, wherein:
the index set to zero references a serving cell.

7. The method of claim 1, wherein the transmitting of the resource set includes:
transmitting a CSI-SSB-ResourceSet information element (IE), wherein the list of the resources and the list of indices are respective fields in the IE.

8. A method for performing inter-cell measurements, the method implemented in a user equipment (UE) and comprising:
receiving, from a radio access network (RAN), a resource set including (i) a list of N resources including synchronization signal block (SSB) indices for signal measurement and (ii) a list of N indices corresponding to the N resources, each index in the list referencing an identifier of a cell with which the signal measurement is associated; and
transmitting, to the RAN, a measurement report based on the resource set.

9. The method of claim 8, wherein:
the identifier of a cell is a physical cell identifier (PCI), and the index is a PCI index.

10. The method of any of claim 8, further comprising:
receiving, from the RAN, a ServingCellConfig information element (IE) including a list of PCIs, wherein the PCI index refers to the list of PCIs.

11. The method of claim 8, wherein:
the index set to zero references a serving cell.

12. The method of claim 8, wherein the receiving of the resource set includes:
receiving a CSI-SSB-ResourceSet information element (IE), wherein the list of the resources and the list of indices are respective fields in the IE.

13. A radio access network (RAN) node comprising:
an antenna set; and
a processing hardware configured, the RAN node configured to:
transmit, to a user equipment (UE), a resource set including (i) a list of N resources including synchronization signal block (SSB) indices for signal measurement and (ii) a list of N indices corresponding to the N resources, each index in the list of N indices referencing an identifier of a cell with which the signal measurement is associated; and
receive, from the UE, a measurement report based on the resource set.

14-15. (canceled)

16. The RAN node of claim 13, wherein:
the identifier of a cell is a physical cell identifier (PCI), and
the index is a PCI index.

17. The RAN node of claim 16, wherein:
the PCI index is in a range of [0, 7].

18. The RAN node of claim 16, wherein:
the PCI is in a range of [0, 1007].

19. The RAN node of claim 13, further configured to:
transmitting, to the UE, a ServingCellConfig information element (IE) including a list of PCIs, wherein the PCI index refers to the list of PCIs.

20. The RAN node of claim 13, wherein:
the index set to zero references a serving cell.

21. The RAN node of claim 13, wherein to transmitting the resource set, the RAN node is configured to:
transmit a CSI-SSB-ResourceSet information element (IE), wherein the list of the resources and the list of indices are respective fields in the IE.
